(19) United States
(12) Patent Application Publication
(10) Pub. No.: US 2026/0281004 A1
(43) Pub. Date: Sep. 17, 2026

(54) Dynamic Updates of Applicability Reporting for AI/ML Models

(71) Applicant: Telefonaktiebolaget LM Ericsson (publ), Stockholm (SE)

(72) Inventors: Icaro Leonardo Da Silva, Solna (SE); Marco Belleschi, Solna (SE); Pradeepa Ramachandra, Linköping (SE); Henrik Rydén, Stockholm (SE); Hernán Felipe Arraño Scharager, Täby (SE)

(21) Appl. No.: 19/168,108

(22) PCT Filed: Apr. 4, 2024
(86) PCT No.: PCT/SE2024/050316

§ 371 Date: Sep. 23, 2025

Related U.S. Application Data
(60) Provisional application No. 63/457,765, filed on Apr. 6, 2023.

(51) Int. Cl. H04L 41/16; H04W 76/27

(52) U.S. Cl. CPC H04L 41/16; H04W 76/27

(57) ABSTRACT

A User Equipment, UE (110), transmits a first completion message indicating whether a model is applicable to a functionality that the UE (110) is configured with. The UE (110) reports, in a second message, that the applicability of the model to the functionality of the UE (110) has changed. The first completion message and second message are received by a network node (120).

This application claims priority to U.S. Provisional patent Application Ser. No. 63/457,765 filed Apr. 6, 2023, the entire contents of which are incorporated herein by reference.

### TECHNICAL FIELD

Embodiments of the present disclosure generally relate to wireless communication networks and, more particularly, relates to modeling wireless communication network features using Artificial Intelligence (AI) and/or Machine Learning (ML) techniques.

### BACKGROUND

Artificial Intelligence (AI) and Machine Learning (ML) have been investigated as promising tools to optimize the design of the air interface in wireless communication networks. Example use cases include using autoencoders for Channel State Information (CSI) compression to reduce the feedback overhead and improve channel prediction accuracy; using deep neural networks for classifying Line-of-Sight (LOS) and Non-Line-of-Sight (NLOS) conditions to enhance positioning accuracy; using reinforcement learning for beam selection (e.g., at the network side and/or the UE side) to reduce the signaling overhead and beam alignment latency; and using deep reinforcement learning to learn an optimal precoding policy for complex Multiple Input Multiple Output (MIMO) precoding problems.

It is expected that 3GPP New Radio (NR) standardization work will explore the benefits of augmenting the air interface with features enabling improved support of AI/ML based algorithms for enhanced performance and/or reduced complexity/overhead. Through studying a few selected use cases (CSI feedback, beam management and positioning), the foundation may soon be laid for future air interface use cases leveraging AI/ML techniques.

### SUMMARY

The present disclosure is generally directed to improving the usefulness of AI/ML models in modeling the PHY in a wireless communication network.

Particular embodiments of the present disclosure include a method, implemented by a User Equipment (UE). The method comprises transmitting a first completion message indicating whether a model is applicable to a functionality that the UE is configured with. The method further comprises reporting, in a second message, that the applicability of the model to the functionality of the UE has changed.

In some embodiments, the first completion message comprises an RRC Setup Complete message, an RRC Resume Complete message, or an RRC Reconfiguration Complete message.

In some embodiments, reporting that the applicability of the model has changed comprises indicating that the model is not applicable. In some such embodiments, reporting that the applicability of the model has changed comprises indicating an alternate model that is associated with the functionality and is applicable. In other embodiments, reporting that the applicability of the model has changed comprises indicating that the model is applicable.

In some embodiments, reporting that the applicability of the model has changed comprises providing a cause value that indicates a reason why the model is or is not applicable.

In some embodiments, reporting that the applicability of the model has changed is responsive to receiving a third message configuring the reporting. In some such embodiments, the third message comprises an RRC Resume message, an RRC Setup message, or an RRC Reconfiguration message.

In some embodiments, the first completion message indicates a plurality of models, each of which is associated with a corresponding functionality that the UE is configured with.

In some embodiments, the second message reports applicability-related information about a plurality of models.

Other embodiments include a UE. The UE is configured to transmit a first completion message indicating whether a model is applicable to a functionality that the UE is configured with. The UE is further configured to report, in a second message, that the applicability of the model to the functionality of the UE (110) has changed.

In some embodiments, the UE comprises interface circuitry and processing circuitry communicatively connected to the interface circuitry. The processing circuitry is configured to transmit the first completion message via the interface circuitry. The processing circuitry is further configured to report that the applicability of the model has changed via the interface circuitry.

In some embodiments, the UE (or processing circuitry thereof) is further configured to perform any one of the methods described above.

Yet other embodiments include a computer program comprising instructions that, when executed on processing circuitry of a UE, cause the UE to carry out any one of the methods described above.

Still other embodiments include a carrier containing said computer program. The carrier is one of an electronic signal, optical signal, radio signal, or computer readable storage medium.

Other embodiments include a method implemented by a network node. The method comprises receiving, from a UE, a first completion message indicating whether a model is applicable to a functionality the UE is configured with. The method further comprises receiving, in a second message from the UE, a report indicating that the applicability of the model to the functionality of the UE has changed.

In some embodiments, the first completion message comprises an RRC Setup Complete message, an RRC Resume Complete message, or an RRC Reconfiguration Complete message.

In some embodiments, the report indicating that the applicability of the model to the functionality of the UE has changed comprises an indication that the model is not applicable. In some such embodiments, the report indicating that the applicability of the model to the functionality of the UE has changed comprises an indication of an alternate model associated to the functionality that is applicable. In other embodiments, the report indicating that the applicability of the model to the functionality of the UE has changed comprises an indication that the model is applicable.

In some embodiments, the report indicating that the applicability of the model to the functionality of the UE has changed comprises a cause value that indicates a reason why the model is or is not applicable.

In some embodiments, the method further comprises transmitting a third message that configures the UE to send the report. Receiving the second message is responsive to transmitting the third message. In some such embodiments, the third message comprises an RRC Resume message, an RRC Setup message, or an RRC Reconfiguration message.

In some embodiments, the first completion message indicates a plurality of models, each of which is associated with a corresponding functionality that the UE is configured with.

In some embodiments, the second message reports applicability-related information about a plurality of models.

Other embodiments include a network node. The network node is configured to receive, from a UE, a first completion message indicating whether a model is applicable to a functionality that the UE is configured with. The network node is further configured to receive, in a second message from the UE, a report indicating that the applicability of the model to the functionality of the UE has changed.

In some embodiments, the network node comprises interface circuitry and processing circuitry communicatively connected to the interface circuitry. The processing circuitry is configured to receive the first completion message from the UE via the interface circuitry. The processing circuitry is further configured to receive the report in the second message from the UE via the interface circuitry.

In some embodiments, the network node (or processing circuitry thereof) is further configured to perform any one of the network node methods described above.

Yet other embodiments include a computer program comprising instructions that, when executed on processing circuitry of a network node, cause the network node to carry out any one of the network node methods described above.

Other embodiments include a carrier containing said computer program. The carrier is one of an electronic signal, optical signal, radio signal, or computer readable storage medium.

### BRIEF DESCRIPTION OF THE FIGURES

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a network node 120, generally, as opposed to discussion of particular instances of network nodes 120a, 120b).

FIG. 1 is a logical block diagram illustrating an example of model lifecycle management, according to one or more embodiments of the present disclosure.

FIGS. 2-10 are signaling diagrams illustrating examples of various embodiments of the present disclosure.

FIG. 11 is a flow diagram illustrating an example method implemented by a UE, according to one or more embodiments of the present disclosure.

FIG. 12 is a flow diagram illustrating an example method implemented a network node, according to one or more embodiments of the present disclosure.

FIG. 13 is a schematic block diagram illustrating an example UE, according to one or more embodiments of the present disclosure.

FIG. 14 is a schematic block diagram illustrating an example network node, according to one or more embodiments of the present disclosure.

FIG. 15 is a schematic block diagram illustrating an example of a communication system in accordance with some embodiments.

FIG. 16 is a schematic block diagram illustrating an example UE, according to one or more embodiments of the present disclosure.

FIG. 17 is a schematic block diagram illustrating an example network node, according to one or more embodiments of the present disclosure.

FIG. 18 is a schematic block diagram illustrating an example host, according to one or more embodiments of the present disclosure.

FIG. 19 is a schematic block diagram illustrating an example virtualization environment, according to one or more embodiments of the present disclosure.

FIG. 20 is a schematic block diagram illustrating communication between a host, network node, and UE, according to one or more embodiments of the present disclosure.

### DETAILED DESCRIPTION

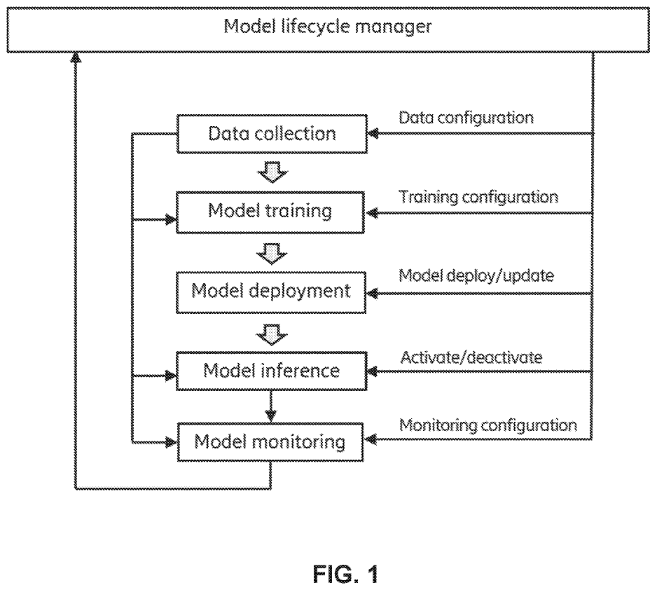

An example high-level logical depiction of AI/ML model Life Cycle Management (LCM) of the Physical Layer (PHY) of a wireless communication network is illustrated in FIG. 1. As shown in FIG. 1, model LCM may include a model lifecycle manager and a plurality of stages. The stages include a data collection stage, a model training stage, a model deployment stage, a model inference stage, and a model monitoring stage. Each of the stages operates on input provided by the model lifecycle manager.

The data collection stage collects and provides input data (raw data or pre-processed data) for the model training stage, model inference stage, and the model monitoring stage. AI/ML algorithm specific data preparation (e.g., data ingestion and data refinement) is not carried out in the data collection stage.

The model training stage uses featured data in terms of training datasets and validation datasets to train an AI/ML model. The model deployment stage converts the AI/ML model into an executable form and delivers it to a target User Equipment (UE) where model inference is to be performed.

The model inference stage uses a deployed AI/ML model to produce a set of outputs based on a set of featured inputs. The model monitoring stage monitors drifts in data and model or monitoring performance metrics after the model has been deployed. Based on the monitored performance, decisions like model activation, deactivation, switching, fallback, and/or selection can be taken.

For purposes of developing 3GPP standards, it may be useful (but not required) to adopt the following definitions:
Data collection: A process of collecting data by the network nodes, management entity, or UE for the purpose of AI/ML model training, data analytics and inference.
AI/ML Model: A data driven algorithm that applies AI/ML techniques to generate a set of outputs based on a set of inputs.
AI/ML model training: A process to train an AI/ML Model (e.g., by learning the input/output relationship) in a data driven manner and obtain a trained AI/ML Model for inference.
AI/ML model Inference: A process of using a trained AI/ML model to produce a set of outputs based on a set of inputs.
AI/ML model validation: A subprocess of training in which the quality of an AI/ML model is evaluated using a dataset different from one used for model training, which helps in selecting model parameters that generalize beyond the dataset used for model training.
AI/ML model testing: A subprocess of training in which the performance of a final AI/ML model is evaluated using a dataset different from that used for model training and validation. In contrast to AI/ML model validation, model testing does not assume subsequent tuning of the model.
UE-side (AI/ML) model: An AI/ML model whose inference is performed entirely at the UE.
Network-side (AI/ML) model: An AI/ML Model whose inference is performed entirely at the network (NW).
One-sided (AI/ML) model: A UE-side (AI/ML) model or a NW-side (AI/ML) model.
Two-sided (AI/ML) model A paired AI/ML Model over which joint inference is performed, where joint inference comprises AI/ML inference performed jointly across the UE and the NW. For example, the first part of inference may be performed by a UE and the remaining part may subsequently be performed by a gNB (or vice versa).
AI/ML model transfer: Delivery of an AI/ML model over the air interface, e.g., by transferring parameters of a model structure known at the receiving end or by transferring a new model with parameters. Delivery may contain a full model or a partial model.
Model download: Model transfer from the NW to UE.
Model upload: Model transfer from UE to the NW.
Federated learning/federated training: A machine learning technique that trains an AI/ML model across multiple decentralized edge nodes (e.g., UEs, gNBs), each performing local model training using local data samples. The technique uses multiple interactions of the model but does not exchange local data samples.
Offline field data: Data collected from the field and used for offline training of the AI/ML model.
Online field data: Data collected from the field and used for online training of the AI/ML model.
Model monitoring: A procedure that monitors the inference performance of the AI/ML model.
Supervised learning: A process of training a model from input and its corresponding labels.
Unsupervised learning: A process of training a model without labelled data.
Semi-supervised learning: A process of training a model with a mix of labeled data and unlabeled data.
Reinforcement Learning (RL): A process of training an AI/ML model from input (a.k.a., state) and a feedback signal (a.k.a., reward) resulting from the model's output (a.k.a., action) in an environment the model is interacting with.
Model activation: Enabling an AI/ML model for a specific function.
Model deactivation: Disabling an AI/ML model for a specific function.
Model identification: Identification of an AI/ML model for common understanding between the NW and the UE. Information regarding the AI/ML model may (or may not) be shared during model identification.
Functionality identification: Identifying an AI/ML functionality for common understanding between the NW and the UE. Information regarding the AI/ML functionality may (or may not) be shared during functionality identification. The functionality may, for example, be identified at a variety of different granularities depending on the embodiment.

To enable the development of models applicable to specific conditions (e.g., scenario, configuration, site, device type, etc.), it may be useful to study ways to associate a dataset with a specific applicability condition. For example, assistance signaling of NW-side applicability information may be used for UE-side data collection. Correspondingly, assistance signaling of UE-side applicability information may be used for NW-side data collection. For purposes of this disclosure, which information is discusses as being “applicability-related,” this may include whether or not a model is applicable. That is, a message reporting that a model is not applicable should generally be considered to be “applicability-related.”

At least for UE-side models and the UE-part of two-sided models, it may be useful to define and study applicable conditions for functionalities/models. These applicable conditions may, e.g., be used to enable development of scenario, configuration, site, and/or other specific models and, if needed, report the models' applicability to the NW. It may also be helpful to study whether and how UE reports applicable conditions for supported functionalities and, if needed, for supported models and/or supported functionalities. Additionally or alternatively, it may be useful to study whether and how to define performance requirements (possibly as part of the applicable conditions) for functionality/models, as well as a potential enhancement of legacy UE reporting features.

Also useful may be procedures, protocols, and signaling for two-sided CSI use case(s). One such example use case may include ensuring UE and gNB side models are configured and/or applied based on their applicable configurations and/or scenarios. Another such example may include ensuring that models are matched properly at both the UE and gNB sides, e.g., when a CSI encoder is used at the UE corresponding CSI decoder is used at the gNB. Yet another such example may include achieving simultaneous activation, deactivation, and/or switching of the two-sided model.

Although models may be useful in general, adoption of such techniques in practice may encounter difficulties. For example, an AI/ML model for a given functionality (e.g., Beam Management, CSI, positioning) may be applicable under certain conditions, but not all conditions. This is especially true in UE-sided models.

For example, a UE capable of performing AI/ML for PHY with respect to a Beam Management functionality may be equipped with an AI/ML model that has not been trained with certain data sets associated with one or more beam configuration(s) and/or with one or more network areas (e.g., wide coverage, lower frequency layers). In such cases, accuracy may not be suitable. Accordingly, the model may be considered inapplicable. Indeed, it may even be impossible to use the AI/ML model in certain conditions.

Even if the UE were to report applicability (e.g., as part of its UE capabilities) together with the fact that the UE is equipped with an AI/ML model for a given functionality (e.g. CSI, Beam Management, positioning), there may still be various problems. For example, AI/ML model applicability may be dynamic (e.g., depending on where the UE is) and may change after model training in response to new conditions. In one particular example, an AI/ML model may not work at one location, but as the UE moves, the AI/ML model may work in another cell the UE has moved to. Additionally or alternatively, the AI/ML model's applicability may work only under certain configurations the network configures the UE with.

Moreover, UE capability reporting does not traditionally involve dynamic characteristics such as the above described applicability of an AI/ML model. Accordingly, traditional UE capability signaling mechanisms (e.g., using Radio Resource Control (RRC) signaling) do not presently have the ability to address a scenario where a model has applicability, and then subsequently does not. For example, for a UE that is configured with AI/ML model based functionality in a RRCReconfiguration message, once an RRCReconfigurationComplete message is sent, the UE will not have an RRC-based means to inform the network that the AI/ML model is not applicable anymore.

To address these challenges described above, embodiments of the present disclosure include a UE configured to report a change in previously-reported applicability information related to at least one AI/ML-model associated with a functionality. According to the method, the UE sends a message that reports an update to the applicability information of at least one AI/ML-model associated to a functionality the UE is configured with. For example, in a first report, the UE indicates non-applicability of the model. However, upon subsequent detection of a change in the applicability, the UE reports a second applicability information (e.g., that the model is applicable).

The first applicability information may have been reported in a completion message (e.g., a message indicating that state transition to connected, has completed, a message indicating that reconfiguration has completed in response to an RRCReconfiguration message received while the UE was already connected, and the like). The second applicability information may be reported in UE assistance information. Such an approach would complement the UE capability at the network side with accurate information regarding whether or not a UE-sided AI/ML model functionality is applicable. In one such example, the UE may signal whether an AI/ML model functionality is capable of being used under certain conditions, e.g., in a given cell or set of serving cells, under a given UE current configuration, etc.

Embodiments of the present disclosure further include reporting a cause value associated with a reasoning for being able to apply the AI-ML model for the functionality. Particular embodiments also include certain configuration options regarding the reporting methods that the UE may use to report when the applicability of a AI-ML model for a functionality is no longer valid.

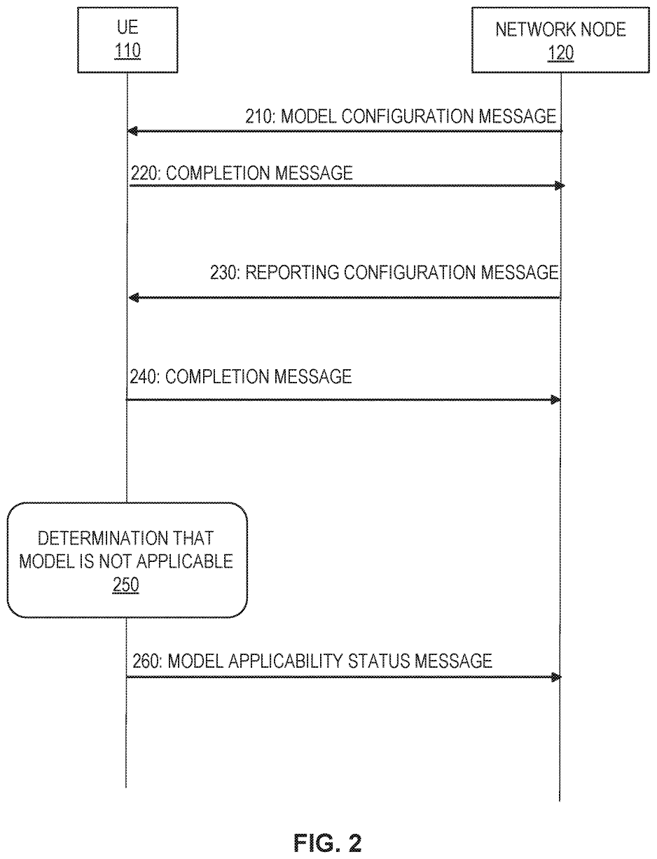

FIG. 2 is a signaling diagram illustrating an example message flow in accordance with particular embodiments of the present disclosure. According to this example, a network node 120 sends a model configuration message to a UE 110 (step 210). The model configuration message configures and/or activates one or more UE-side AI/ML models. In response, the UE 110 sends a first completion message to the network node 120 (step 220). The first completion message indicates that the one or more UE-side AI/ML models were successfully applied. The network node 120 then sends a reporting configuration message to the UE 110 (step 230). The reporting configuration message configures the UE to report the applicability (or lack thereof) of the model(s). In response, the UE 110 sends a second completion message to the network node 120 (step 240).

The UE 110 then determines that one or more of the model(s) is no longer applicable (step 250). In response, the UE 110 sends a model applicability status message to the network node 120 (step 260). The model applicability status message indicates that the one or more model(s) are no longer applicable. In some embodiments, the model applicability status message also includes a cause value that indicates a reason why the model does not apply. In other embodiments, the applicability status message additionally or alternatively includes an indication of another model that is associated with the functionality that is applicable (e.g., so that the other model may be used instead).

The messages used to communicate between the UE 110 and the network node 120 may take a variety of forms, depending on the embodiment. That said, particular embodiments use RRC signaling for this purpose. For example, either or both of the completion messages may be any of: an RRC Setup Complete message, an RRC Resume Complete message, or an RRC Reconfiguration Complete message. As another example, the model applicability status message may be an RRC Resume message, an RCE Setup message, or an RRC Reconfiguration message. These RRC messages, other RRC messages, or appropriate messages of another protocol may additionally or alternatively be used for any of the messages illustrated in any of embodiments discussed herein as well (e.g., the embodiments illustrated in FIGS. 2-10).

Although the example of FIG. 2 illustrates the model configuration message and reporting configuration message as separate messages, it should be noted that in some embodiments a single configuration message could be used to provide similar functionality.

Thus, particular embodiments of the present disclosure enable the network to be continuously aware of the applicability status of an AI/ML model for a corresponding functionality while a given RRC configuration (e.g., as received in an RRC Setup message, RRC Resume message, or RRC Reconfiguration message) is applied by the UE 110. Thus, variation in the applicability criterion of the model within the coverage area of a cell can be dynamically taken into account by the network in its decision making.

In this disclosure, the terms “ML-model”, “AI-model,” “AI/ML model,” or simply “model” are interchangeable. The model can be implemented in a first node (e.g., a UE, in the case of a UE-sided model). In some embodiments, the model can indicate a feature version to a second node. If the model is updated, the feature version may be changed by the first node.

A model as disclosed herein may correspond to a function that receives one or more inputs (e.g. measurements, configuration(s)) and provide as outcome one or more prediction(s) or estimates of a certain type (e.g. time-domain and/or spatial domain predictions of beam measurements). In one example, an ML-model may correspond to a function receiving as input the measurement of a reference signal at time instance to (e.g. transmitted in beam-X) and provide as outcome the prediction of the reference signal in timer t0+T. In another example, an ML-model may correspond to a function receiving as input the measurement of a reference signal X (e.g. transmitted in beam-x), such as a Synchronization Signal Block (SSB) whose index is ‘x’, and provide as outcome the prediction of other reference signals transmitted in different beams e.g. reference signal Y (e.g. transmitted in beam-x), such as an SSB whose index is ‘x’. Another example is a ML model for aid in CSI estimation, in such a setup the ML-model will be specific ML-model with a UE and an ML-model within the NW side. Jointly both ML-models provide joint network. The function of the ML-model at the UE would be to compress a channel input and the function of the ML-model at the NW side would be to decompress the received output from the UE. It is further possible to apply something similar for positioning wherein the input may be a channel impulse in some form related to a certain reference point (typically a TP (transmit point)) in time. The purpose on the NW side would be to detect different peaks within the impulse response, that reflects the multipath experienced by the radio signals arriving at the UE side. For positioning another way is to input multiple sets of measurements into an ML network and based on that derive an estimated position of the UE. Another ML-model would be an ML-model to be able to aid the UE in channel estimation or interference estimation for channel estimation. The channel estimation could for example be for the PDSCH and be associated with specific set of reference signals patterns that are transmitted from the NW to the UE. The ML-model will then be part of the receiver chain within the UE and may not be directly visible within the reference signal pattern as such that is configured/scheduled to be used between the NW and UE. Another example of an ML-model for CSI estimation is to predict a suitable CQI, Precoding Matrix Indicator (PMI), Rank Indicator (RI), CSI-Reference Signal (CRS) resource indicator (CRI) or similar value into the future.

The network may comprise a generic NW node, gNB, base station, unit within the base station to handle at least some ML operation, relay node, core network node, a core network node that handles at least some ML operations, a device supporting Device-to-Device (D2D) communication, a Location Management Function (LMF) or other types of location server.

In terms of the time, frequency, and/or spatial domain, the output of the AI/ML model may be in a different time instance, or at a different frequency location, or at a different spatial direction, or a combination of time/frequency/space, than those of the model input. In a time domain example, an ML-model may correspond to a function receiving as input the measurement of a reference signal at time instance to (e.g., transmitted in beam-X) and provide as outcome the prediction of the reference signal at time instance t0+T. In a spatial domain example, an ML-model may correspond to a function receiving as input the measurement of a reference signal X (e.g., transmitted in beam-x, such as an SSB whose index is ‘x’), and provide as outcome an estimation or prediction of the link quality of other reference signals transmitted in different beams (e.g. reference signal Y transmitted in beam-y).

In terms of model structure, the ML model may be fully contained within the UE, or split between the UE and network. One example of split structure is a ML model for aid in CSI estimation, where a possible setup of the ML-model is a split model, which comprise a specific sub-model within a UE and a sub-model within the NW side which collaborate to generate a desired outcome for the overall ML model. The function of the sub-model at the UE would be to compress a channel input and the function of the sub-model at the NW side would be to decompress the received output from the UE. It is further possible to apply something similar for positioning wherein the input may be a channel impulse in some form related to a certain reference point in time. The purpose on the NW side would be to detect different peaks within the impulse response, that corresponds to different reception directions of radio signals at the UE side.

One example of model contained within the UE is for enhanced positioning, e.g., an ML model implemented in the UE may take as input multiple sets of measurements (each corresponding to a downlink signal from a different network node) and based on that derive an estimated position of the UE.

In terms of utility for the PHY, the ML model can be used for many functions, including (for example) channel estimation, LOS/NLOS classification, beam selection, position estimation of the UE, link adaption, etc. For example, an ML-model may be able to aid the UE in channel estimation which may or may not incorporate interference estimation. The channel estimation could for example be for the Physical Downlink Scheduled Channel (PDSCH) and be associated with specific set of reference signals patterns that are transmitted from the NW to the UE. The ML-model will then be part of the receiver chain within the UE and may not be directly visible within the reference signal pattern as such that is configured/scheduled to be used between the NW and UE. Another example of an ML-model for CSI estimation is to predict a suitable CQI, PMI, RI or similar value into the future. The future may be a certain number of slots after the UE has performed the last measurement or targeting a specific slot in time within the future.

According to various embodiments, the UE is connected to the network (e.g., the UE may receive and transmit data and/or control information) in RRC_CONNECTED state and is configured to perform a specific function by using an AI/ML-model (which may be referred as an AI/ML-model functionality). The function may be, for example, beam measurement predictions in time-domain. The function of the model may be, for example, for one of the following, which could also be grouped as a functionality area (one or more AI/ML-model functionality per area):
CSI reporting
Beam management (BM)
Radio Resource Management (RRM) measurement
Link adaptation
Hybrid Automatic Repeat reQuest (HARQ) transmission
Data transmission
Data reception
Power control
Positioning of the UE
Random access transmission
Energy efficiency (e.g., Discontinuous Reception (DRX) settings) For example, there may be a BM functionality of an AI/ML-model(s) in which a model (e.g. at the UE) is capable of inferring one or more time-domain predictions related to BM. For example, the UE may be configured by the network to report (e.g., on the Physical Uplink Control Channel (PUCCH) and/or Physical Uplink Shared Channel (PUSCH)) one or more time-domain predictions of SSB and/or CSI-RS and/or Phase Tracking Reference Signal (PTRS) measurements (e.g., by receiving a reporting configuration for AI/ML). Other examples may additionally or alternatively include inferring one or more frequency-domain and/or spatial-domain predictions or estimates related to beam management.

The UE is considered to be configured with a AI/ML functionality when at least one action related to that functionality is configured. For example, the UE 110 may be configured to report BM and/or CSI and/or SSB predictions to one a configured serving cell.

As another example, the model may be for mobility measurement (e.g., Reference Signal Received Power (RSRP), Reference Signal Received Quality (RSRQ), Received Signal Strength Indicator (RSSI)) and/or aspects related to Radio Link Failure (RLF) (e.g., predicting RLF). Further, Radio Link Monitoring (RLM) related timer (e.g., T310) and/or counter (e.g., N310 and N311) related predictions could also be performed using the model.

In particular, the model may be used for measurement, prediction, or estimation as part of the measurement framework defined in 3GPP TS 38.331 § 5.5 describing how the UE perform measurements (e.g., measurement configuration), what triggers measurement reports (e.g., event-triggered reports, periodic reports), and content to be included in measurement reports.

The methods disclosed above may be applicable to the AI/ML model(s) associated to an AI/ML model functionality, or to the AI/ML model functionalities interchangeably.

An AI/ML-model is applicable for a given functionality when it can be configured and used (e.g. by a UE, in the case of UE-sided models) under the relevant conditions. For example, an AI/ML-model for a functionality may be considered applicable when the AI/ML model is able to produce outputs (e.g., time-domain predictions of beam measurements with sufficient accuracy). Accuracy for BM, for example, may be quantified in terms of an average Layer 1 (L1) RSRP difference of the Top-1 predicted beam in comparison to the ideal beam (sweep all beams). Alternatively, accuracy can be deemed the Cumulative Distribution Function (CDF) percentile of L1-RSRP difference for Top-1 predicted beam. The beam prediction accuracy percentage may have a 1 dB margin for Top-1 beam, for example.

In another example, the UE may further receive from the NW a certain threshold to compare with accuracy Key Performance Indicators (KPIs) to understand if the model is applicable.

In another example, a model may be considered applicable when it is able to make predictions having at least a threshold confidence value. If the UE 110 is able to estimate how confident each prediction is, the NW can on a per-input sample basis decide whether to use the prediction. That is, the model may be considered “applicable” for some of its experienced data (and perhaps not for others). For example, the UE can report a predicted confidence interval (downlink and/or uplink) where the predicted L1-RSRP/Signal to Interference and Noise Ratio (SINR) of a beam with a x probability resides (e.g., the L1-RSRP has a 95% probability of being in SINR range of [8 dB, 10 dB]).

A predicted value can be reported as a probability density function using, e.g., Gaussian mixtures. The prediction may then be reported using the parameters describing the mixed gaussian components (e.g., mean, variation, and component weight for each of the components).

A model may additionally or alternatively be considered appliable when it has collected and trained a model in the current UE configuration/scenario, where the model is not older than a certain threshold value T, and/or when the NW can determine T based on, e.g., deployment changes (new beam pattern, new cells etc.).

An AI/ML-model for a functionality may be considered not applicable when the AI/ML model is either unable to produce certain outputs or produces outputs without sufficient accuracy. If the UE has multiple AI/ML-models for the same functionality in which different models are applicable for different scenarios, one may say that the AI/ML-model is not applicable for a functionality when none of the AI/ML-models for that functionality are applicable. Otherwise, instead of reporting inapplicability, the UE may simply switch to another model that is applicable for that functionality. Similarly, one may say that the AI/ML-model is applicable for a functionality when at least one of the AI/ML-models for that functionality is applicable when the UE is configured.

According to the method, there may be different reasons for an AI/ML-model not being applicable. These reasons may include, for example, location (e.g., geographic area), UE configuration, network configuration, and/or mobility characteristics.

With respect to location, an AI/ML-model for a functionality may be applicable in a first area of a network the UE is registered to, but the same AI/ML-model for the functionality might not be applicable in a second area of a network the UE is registered to. For example, when the UE camps in cell A while in the IDLE state and transitions to the CONNECTED state, the AI/ML-model for the functionality may be considered applicable for cell A. However, if the UE in the IDLE state performs cell reselection and moves to a cell C, the AI/ML model for the functionality may not be applicable. One reason for this may be that the training data set used for training the AI/ML model may be representative of a first area but not a second area.

A “location” in this context may comprise one or more of the following:
One or more cells (e.g., defined by one or more cell identifiers, such as Global Cell Identifiers)
One or more tracking areas
One or more tracking area codes
One or more registration areas
One or more Radio Access Network (RAN)-based notification areas
GPS location
GPS delimited area
The coverage area of a list of Wireless Local Area Network (WLAN) Access Points (APs)
The coverage area of a list of Bluetooth beacons
Within a given type of deployment (e.g., small cells, large cells, indoor, outdoor)
A list of Public Land Mobile Networks (PLMNs) and/or Non-Public Network (NPN) Identifiers (for example, a NPN ID could indicate a specific factory setting and any training data used in the factory could be applicable only inside such a factory and not elsewhere)

With respect to UE configuration, an AI/ML-model for a functionality may be applicable when the UE is configured with a first configuration (e.g., using a first RRCReconfiguration message or information element (IE)). However, the same AI/ML-model for the functionality might not be applicable when the UE is configured with a second configuration (e.g., using a second RRCReconfiguration message or IE). Depending on the embodiment, the first and/or second configuration may configure lower layers, bearer configuration, measurement configuration(s), MIMO layers configuration, etc.

Thus, when the UE transitions to the CONNECTED state (for example) and receives a configuration equivalent to the first configuration, the AI/ML-model for the functionality may be applicable. However, if the UE transitions to the CONNECTED state and receives a configuration equivalent to the second configuration, the AI/ML-model for the functionality may be considered inapplicable.

One reason why one configuration may be considered applicable and the other considered not applicable is that the training data set used for training the AI/ML model for a given UE configuration may lead to a model which does not produce accurate outputs (in inference) for one or more UE configurations. For example, the AI/ML-model for the functionality may be applicable for predictions of measurements in a first set of frequencies (e.g., in Frequency Range 1 (FR1) and/or particular frequencies (e.g., f0, f1, f2)) but not for predictions of measurements in a second set of frequencies (e.g., Frequency Range 2 (FR2) and/or frequencies f7, f8, f9). Another reason could be that the AI/ML model is trained using a certain CSI-RS periodicity. For example, the UE may expect a 20 ms periodicity to be able to perform a forecast of the channel for the next 10 ms (in-between measurements). However, the UE may be configured with aperiodic CSI-RS or 40 ms periodicity, thereby making the model inaccurate.

Network configuration aspects that may have relevance to whether or not a model is considered appliable may include single beam vs multi-beam, configuration information broadcast by the network, and/or beamforming pattern. For example, the NW may indicate that it performs beam predictions, CSI predictions, and/or positioning using AI/ML. That is, if the network uses network-based AI/ML models, the NW may indicate that the UE should not activate such features, for example.

Additionally or alternatively, a UE's mobility characteristics may be relevant to whether a model is applicable. For example, an AI/ML-model for a functionality may be applicable when the UE's mobility characteristics are of one category, and not applicable when the UE's mobility characteristics are of a second category. In one particular example, a UE might be slow speed (as classified by the UE based on its sensor based measurements and/or a network defined criterion like speedStateReselectionPars as defined in the RRC specification, TS 38.331v 17.3 ) and the training data used to train the AI-ML model is exclusively in this mobility class. However, at the time of transitioning from the idle to inactive state, if the UE is in a different mobility class, then the AI/ML model for the functionality may not be applicable, for example. For purposes of this disclosure, the idle, inactive, and connected states are states that the UE 110 is in with respect to its connectivity to the network. These terms are to be interpreted in accordance with 3GPP standards.

In another example, temporal beam predictions may be applicable based on UE mobility. In one such example, temporal beam predictions may be applicable based on whether the UE is moving at a constant or near-constant speed. In another example, temporal beam predictions may be applicable based on the type of mobility (e.g., in a vehicle or train that can provide a more predictable trajectory). In yet another example, temporal beam predictions may be applicable based on whether or not the UE is rotating.

Features relating to reporting the applicability of a model according to various embodiments will now be discussed. In a set of such embodiments, after sending a completion message (RRCReconfigurationComplete or RRCResumeComplete) in which the UE acknowledges the applicability of a AI/ML model functionality, if the UE determines that the AI/ML-model functionality is not applicable anymore under the current UE configuration and existing condition(s) e.g. location of the UE, then the UE reports the non-applicability of the AI-ML model functionality to the network.

In one option, when the UE determines that the AI/ML-model functionality is not applicable the UE includes the indication in the UE Assistance Information message, and transmits the UE Assistance Information message to the network node, wherein the indication is indicating that one or more AI/ML-model functionalities that were previously acknowledged are not applicable anymore (e.g. under current scenario(s) and/or configuration).

In one option, when the UE determines that the AI/ML-model functionality is not applicable the UE deactivates the AI/ML-model functionality. That action may be combined with the reporting of the indication of the non-applicability in the UE Assistance Information message.

In one option, when the UE determines that the AI/ML-model functionality is not applicable the UE autonomously switches to another AI/ML-model functionality that has been pre-configured (but not previously activated) by the network. The benefit here is that if the network node does not want to bother about the non-applicable AI/ML-WO model(s) when it knows that there are other potential AI/ML models that could be applicable. However, the UE's switching and activation action may be combined with the reporting of the indication of the non-applicability in the UE Assistance Information message, as the NW might want to keep track of non-applicability issues (e.g., with a model, or with a configuration), or alternatively, since there could be cases on which none of the pre-configured AI/ML-model functionalities are applicable.

In one option, when the UE determines that the AI/ML-model functionality is not applicable the UE releases the configuration(s) of the AI/ML-model functionality. That action may be combined with the reporting of the indication of the non-applicability in the UE Assistance Information message. The benefit here is that if the network node does not want to bother about the non-applicable AI/ML-model(s) it would not have to, as they would be released by the UE.

In one option, when the UE determines that the AI/ML-model functionality is not applicable the UE autonomously switches the configuration(s) to a default configuration that was configured by the network as a fallback functionality. That action may be combined with the reporting of the indication of the non-applicability in the UE Assistance Information message. The benefit here is that if the network node does not want to bother about the non-applicable AI/ML-model(s) it would not have to, as they would be released by the UE and also the basic functionality can still carry on via a non AI/ML model based framework. For example, when the AI-ML model for the L1-RSRP prediction of beam management functionality is not applicable anymore, then the UE switches to reporting the actual measured L1-RSRP values instead of including the predicted L1-RSRP in the L1 reporting. In some embodiments, the lack of predicted values associated to such a functionality is taken as an implicit indication that the AI/ML model for this functionality is not applicable anymore and in some other embodiments, the UE explicitly includes the indication in the UE Assistance Information message and in some embodiments, both explicit and implicit methods are used as they are reported to different network nodes hosting different network functionalities.

In some embodiments, one or more fallback configurations are specified for each of the AI/ML functionality individually. For example, a fallback configuration of CSI reporting is configured to the UE that would be applicable only when the AI/ML model based functionality becomes not applicable. In case of multiple fallback configurations for a certain AI/ML functionality, the UE indicates in the reporting the fallback configuration that the UE has selected

In some embodiments, there are one or more fallback configuration applicable to all the AI/ML functionalities configured to the UE. For example, there is a single fallback RRCReconfiguration that the UE applies upon realizing at least one (in some embodiments) or all of the (in some other embodiments) AI-ML model functionalities configured to the UE is/are not applicable anymore. In case of multiple fallback configurations applicable to all the AI/ML functionalities, the UE indicates in the reporting the fallback configuration that the UE has selected.

In one option, when the UE determines that the AI/ML-model functionality is NOT applicable, along with adopting one of the methods above, the UE also includes an indication in the UE Assistance Information message, the indication indicating the applicable configuration for one or more AI/ML-model functionality(ies) that would be applicable in the current configuration and scenario. For example, if the UE is configured to perform predicted L1-RSRP reporting of serving cells on F1, F2 and F3 frequencies in the configuration, then the UE could indicate that the UE is not able to apply such a configuration but the UE can report predicted L1-RSRP report on F1 and F2 frequencies based on its AI-ML model in the current configuration and scenario. The UE may indicate one or more of these recommendations or suggestions of reconfigurations to make the AI/ML-model functionality applicable. For example, a recommendation may include one or more of:
A new set of frequencies whose predictive measurements can be predicted by the applicable AI/ML models;
A new set of serving cells whose predictive measurements can be predicted by the applicable AI/ML models
A new reference signal configuration for reporting and/or performing inference and/or predictions (e.g., the network may have configured the UE to perform time-domain predictions of CSI-RS measurements, while for that cell the AI/ML-model functionality is NOT applicable for CSI-RS but it is applicable for SSB(s), so that the UE indicates that to the network). The UE can, for example, suggest a new CSI-RS periodicity;
A new MIMO configuration;
A new CSI-MeasConfig.

In one option, an indication indicating when in time the AI/ML-model functionality is expected to be applicable again, which can depend for example on temporarily shortage of computational resources, or a new received configuration. In another example, the UE may indicate that the AI/ML-model functionality is applicable when the UE enters a low mobility state.

In one option, each AI/ML-model functionality configuration is associated to at least one identifier such as a reporting configuration ID. When the UE indicates the AI/ML-model functionality which is not applicable, the UE may include such an identifier. Consider an example in which a UE has been configured with a plurality of reporting configurations 1 through 6, each associated with one of three AI/ML models A, B, or C. In this example, model A is associated with prediction reporting configuration ID=1 and prediction reporting configuration ID=2. Model B is associated with prediction reporting configuration ID=3 and prediction reporting configuration ID=4. Model C is associated with prediction reporting configuration ID=5 and prediction reporting configuration ID=6. When model C is determined to be not applicable, the UE may include in a completion or status message the corresponding configuration identifiers and its applicability, e.g., as follows:
Prediction reporting configuration ID=5: not applicable;
Prediction reporting configuration ID=6: not applicable;

In one option, a cause value or further applicability information is included in the message. In particular, the UE 110 may indicate one or more cause values associated to an AI/ML-model functionality reported as non-applicable. The cause value may indicate, for example:
A non-applicable network location (e.g., the UE is connected to a cell for which the AI/ML-model functionality does not provide outputs and/or provide outputs with inadequate accuracy and/or high errors and/or uncertainties);
A non-applicable AI/ML-model output (e.g., the model cannot provide a confidence measure of its prediction needed by the NW to utilize the predictions. For example, the NW may use the confidence of the prediction to set how many beams to transmit);
The AI/ML-model is too old (e.g., the NW can determine that models older than a certain time are invalid, e.g., due to NW changes);
A non-applicable UE configuration (e.g., the UE has been configured to report on frequency layers for which the AI/ML-model functionality is not trained);
A non-applicable network configuration (e.g., the UE is connected to a network with a configuration for which the AI/ML-model functionality is not trained);
A non-applicable UE mobility criterion (e.g., UE has trained the model using measurements while it is a slow speed UE, whereas the UE's current mobility class is high speed).
A non-applicable CSI-RS configuration (e.g., the network is providing CSI-RS resources for channel estimation with a configuration for which the AI/ML-model functionality is not trained);
A non-applicable computational resource availability (e.g., computational resources at the UE are limited, which may be impacted by UE configurations and traffic patterns)

Features relating to the association of a configuration to the reporting of model applicability will now be discussed. In a set of embodiments, the UE is configured with additional information related to the reporting of the applicability of a AI/ML model functionality. In some embodiments, such a configuration is provided per AI/ML model functionality whereas in some other embodiments, such a configuration is common to more than one or all of the AI/ML model functionalities.

In some embodiments, such a configuration is provided as part of the otherConfig field in the RRCReconfiguration message. In such embodiments, such a configuration is not stored after transitioning from RRC Inactive state to RRC Connected mode.

In some other embodiments, such a configuration is provided as part of the RRCReconfiguration message that is stored in the UE context (e.g., masterCellGroup field in RRCReconfiguration message) and that is restored upon state transition from RRC Inactive state to RRC connected mode.

Such a configuration may, for example, include a reporting criterion, e.g., a non-applicability criterion entering and/or a non-applicability criterion leaving a particular state. For example, the network could configure the UE with an indication indicating whether the UE is to send non-applicability related information when the AI-ML model for a functionality is not applicable anymore, or in the case where the UE has a set of preconfigured AI/ML models for a functionality, when none of the models are applicable. Upon realizing that an AI/ML model for a functionality is no longer applicable, the UE may send a UEAssistanceInformation message with an indication as described above.

The network may configure the UE with an indication indicating whether the UE is to send a applicability related information once the AI-ML model for a functionality becomes applicable. Upon realizing that an AI/ML model for a functionality has become applicable, or in the case of having a set of preconfigured AI/ML models, when one or more of them become applicable, then the UE may send the UEAssistanceInformation message with an indication to indicate that the one or more AI/ML models for the functionality are applicable again. It should be noted that the network may configure the UE with both of the above indications or only one of them, for example.

The reporting configuration may additionally or alternatively include a periodicity of reporting the non-applicability of the AI-ML model for a functionality. For example, the network could configure the UE with a reporting interval so that the UE does not report this information more often than it is expected from the network side.

The reporting configuration may additionally or alternatively include a prohibit timer that prevents the reporting of two consecutive non applicability information for an AI/ML model functionality within a given interval. This mechanism would serve to prevent the UE from sending a second non-applicability information report within a given time window after transmission of a first non-applicability information report for the same AI/ML model functionality. This timer may be stopped if, after the transmission of the first non-applicability information report, the network provides a configuration that affects the AI/ML model functionality (e.g., such that the AI/ML model functionality becomes applicable, is deactivated, or is unconfigured.

The reporting configuration may include an evaluation duration before reporting the non-applicability of the AI-ML model for a functionality. That is, the network could configure the UE with an indication that indicates how long the UE should evaluate the applicability/non-applicability evaluation before declaring that the AI-ML model for the functionality is not applicable. Such a configuration ensures that the network can take uniform action for different UEs despite different UEs implementing different UE based AI/ML model for a functionality.

In some such embodiments, this indication is configured in terms of time duration. In other such embodiments, this indication is configured in terms of number of output samples (e.g., counters) of a AI/ML model for a functionality.

The reporting configuration may include a time-to-trigger during which the UE should deem the non-applicability criterion to be fulfilling for the AI-ML model of a functionality. That is, the network may configure the UE with an indication that indicates for how long the UE should deem the AI-ML model to be applicable or not-applicable before declaring that the AI-ML model for the functionality is or is not applicable. Such a configuration ensures that the network does not get too many reports when the AI/ML model's outputs are varying with high uncertainty.

The reporting configuration may include whether to monitor those UE-sided AI/ML model functionalities that are indicated to be not applicable at the time of sending the RRCReconfigurationComplete message that carries the list of applicable or not-applicable UE-sided AI/ML model functionalities. For example, the network could indicate to the UE to continue to monitor the applicability status of L1-RSRP prediction related AI/ML model functionality despite the UE indicating that it cannot apply the said AI/ML model functionality. This may, for example, enable the network to be more opportunistic in terms of getting to know if the UE's AI/ML model functionality becomes applicable and the network can use such a functionality to improve the UE and the network KPIs.

Details relating to the transmission of applicability criterion after sending receiving a RRCReconfiguration message will now be discussed. In a set of embodiments, a UE in RRC Connected mode receives a configuration message (e.g. an RRC Reconfiguration message like RRCReconfiguration as defined in TS 38.331). The configuration message attempts to configure and/or activate the UE with one or more AI/ML-model functionalities. For example, an AI/ML functionality may correspond to the UE being configured to report and/or perform one or more time-domain predictions of SSB and/or CSI-RS measurements. The report may be sent to one or more serving cells of the UE. The measurements may be taken, e.g., of resources associated with one or more of the serving cells of the UE.

In another example, an AI/ML functionality may correspond to the UE being configured to report and/or perform one or more spatial-domain predictions of SSB and/or CSI-RS measurements. The measurements may be taken of resources associated with a serving cell that the UE is configured with.

As another example, an AI/ML functionality may correspond to the UE being configured to report and/or perform CSI predictions. Another example includes an AI/ML functionality that corresponds to the UE being configured to report and/or perform positioning predictions. The UE may be configured with models for one, some, or any combination of these functionalities.

In response of being configured with one or more AI/ML-model functionalities, the UE transmits a completion message to the network (e.g., an RRC Reconfiguration Complete message) including at least one indication indicating that at least one of the configured (or to be configured/to be activated) AI/ML-model functionalities is applicable. In some embodiments, the UE transmits the completion message in response to determining that the AI/ML-model is applicable.

The UE receives a configuration message (e.g. RRC Reconfiguration, like an RRCReconfiguration message as defined in TS 38.331) that configures the UE to report applicability or non-applicability relating to one or more AI/ML-model functionalities. In some embodiments, this configuration message is same as the configuration message in which the configuration and/or activation of one or more AI/ML-model functionalities was received. In some such embodiments, if the UE has received the configuration to report the applicability (or non-applicability) related reporting for one or more AI/ML-model functionalities, the UE deems those configurations to be active when the UE indicates that one or more of those AI/ML model functionalities applicable.

In response of being configured with applicability-related reporting for one or more AI/ML model functionalities, the UE transmits a completion message to the network (e.g. an RRC Reconfiguration Complete message) and monitors the applicability of the one or more AI/ML model functionalities. In some embodiments, this completion message is the same as the completion message in which the configuration and/or activation of one or more AI/ML-model functionalities was acknowledged.

After transmitting the completion message, the UE continues to monitor the applicability of AI/ML model(s) for the functionality for which the UE had acknowledged that the AI/ML-model is applicable in the completion message. If the UE determines that one or more AI/ML models for the functionality are not applicable, then the UE may transmit an indication in a message (e.g., UEAssistanceInformation) to the network. The indication may indicate that at least one of the configured AI/ML model functionalities is not applicable.

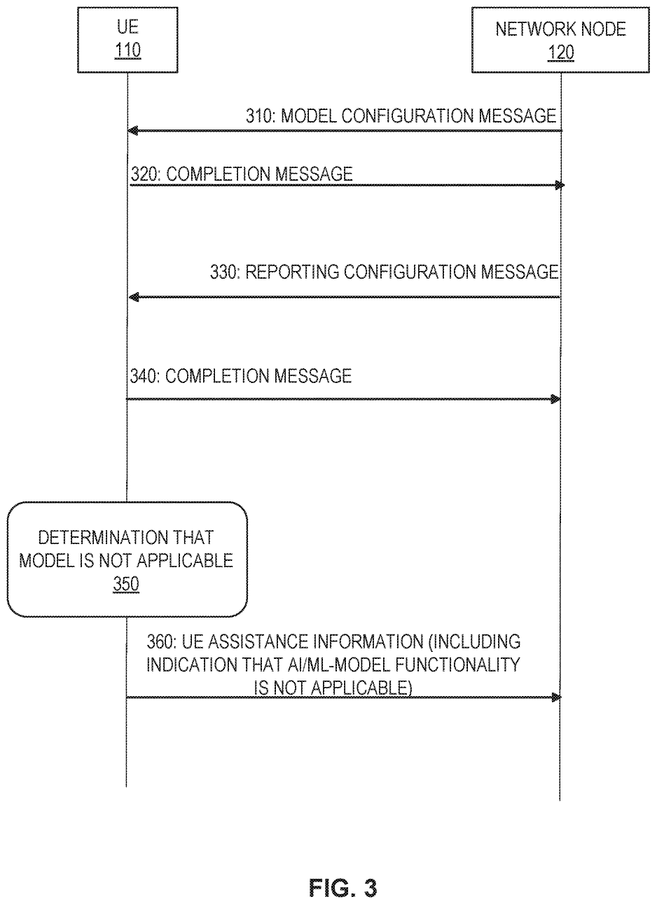

An example is shown in the signaling diagram of FIG. 3. In the example of FIG. 3, configuration/activation of a UE-side AI/ML model functionality was received in a different RRCReconfiguration message compared to the configuration to report the non-applicability of one or more of those UE sided AI/ML model functionalities that the UE had acknowledged in the previous RRCReconfigurationComplete message.

That is, at step 310, the UE 110 receives, from a network node 120, a first RRC Reconfiguration message to configure/activate a UE-sided AI/ML model. At step 320, the UE 110 sends, to the network node 120, a first RRC Reconfiguration Complete message indicating successful application of the UE-sided AI/ML model. At step 330, the UE 110 receives, from the network node 120, a second RRC Reconfiguration complete message to configure reporting of applicability-related information of the UE-sided AI/ML model. At step 340, the UE 110 sends, to the network node 120, a second RRC Reconfiguration Complete message. At step 350, the UE 110 determines that an AI/ML model for the functionality is not applicable. At step 360, the UE 110 sends, to the network node 120, UE assistance information that includes an indication that the AI/ML model is not applicable.

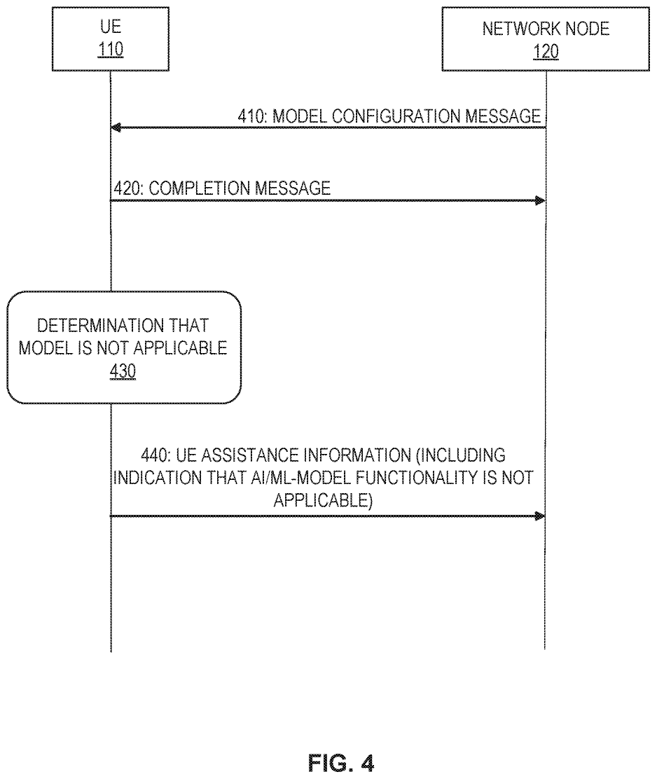

Another example is shown in the signaling diagram of FIG. 4. In the example of FIG. 4, the configuration/activation of the UE-side AI/ML model functionality and the configuration to report the non-applicability of one or more of those UE sided AI/ML model functionalities that the UE can apply currently is in the same RRCReconfiguration message. In such an example, the UE would initiate the monitoring of the applicability of one or more UE-sided AI/ML model functionalities upon transmitting the RRCReconfigurationComplete message in which it indicates that the one or more UE sided AI/ML model functionality are successfully applied currently. This acts as an implicit way in which the network knows that the UE is performing applicability monitoring for at least these UE sided AI/ML model functionalities.

According to the example of FIG. 4, at step 410, the UE 110 receives, from a network node 120, a first RRC Reconfiguration message to configure/activate a UE-sided AI/ML model. The first RRC Reconfiguration message also configures reporting of applicability-related information of the UE-sided AI/ML model. At step 420, the UE 110 sends, to the network node 120, a first RRC Reconfiguration Complete message indicating successful application of the UE-sided AI/ML model. At step 430, the UE 110 determines that an AI/ML model for the functionality is not applicable. At step 440, the UE 110 sends, to the network node 120, UE assistance information that includes an indication that the AI/ML model is not applicable.

Features relating to the transition of a UE 110 from an inactive state for configuration and reporting, according to various embodiments, will now be discussed. In a set of embodiments, a UE in an inactive state (e.g. RRC_INACTIVE) transmits to the network (e.g., a gNodeB) a request message (e.g., an RRC Resume Request message, like RRCResumeRequest or RRCResumeRequest 1 as defined in TS 38.331) and receives a response message (e.g. RRC Resume, like an RRCResume message as defined in TS 38.331) based on which the UE enters a connected state (RRC_CONNECTED), wherein the response message (e.g., RRCResume) configures (and/or activates) or tries to configure the UE 110 with one or more AI/ML-model functionalities.

For example, a first AI/ML functionality may correspond to the UE being configured to report and/or perform (e.g. to one of its configured serving cell(s)) one or more time-domain predictions of SSB and/or CSI-RS measurements (e.g. of resources associated to one of its configured serving cell(s)). A second AI/ML functionality may correspond to the UE being configured to report and/or perform (e.g. to one of its configured serving cell(s)) one or more spatial-domain predictions of SSB and/or CSI-RS measurements (e.g. of resources associated to one of its configured serving cell(s)). A third AI/ML functionality may correspond to the UE being configured to report and/or perform CSI predictions. A fourth AI/ML functionality may correspond to the UE being configured to report and/or perform positioning predictions.

In response of being configured with one or more AI/ML-model functionalities, the UE transmits a completion message to the network (e.g. an RRC Resume Complete message) including at least one indication indicating that at least one of the configured (or to be configured/to be activated) AI/ML-model functionalities which are being configured (and/or activated) is applicable (e.g., responsive to the UE determining that the AI/ML-model is applicable).

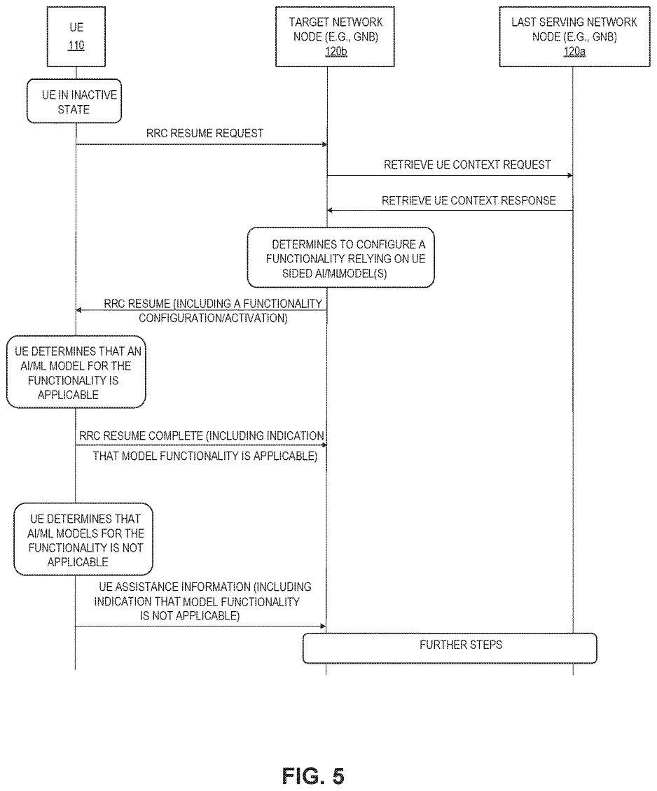

After transmitting the completion message, the UE continues to monitor the applicability of one or more AI/ML models for the functionality for which the UE had acknowledged that the AI/ML-model is applicable in the completion message. If the UE determines that AI/ML model(s) for the functionality are not applicable, then the UE transmits an indication in a message (e.g., UEAssistanceInformation) to the network, the indication indicating that at least one of the configured AI/ML model functionality(ies) is not applicable. An example of an embodiment in which a UE indicates that an AI/ML model functionality is not applicable is shown in FIG. 5.

It should be noted that, in some embodiments, neither AI/ML model functionality configuration nor the configuration related to the reporting of applicability-related information of the AI/ML model functionalities is stored in the UE context. Such embodiments are similar in some respects to those mentioned previously in that the UE receives a configuration message (e.g., RRCReconfiguration) that indicates the AI/ML model functionality configuration and the configuration related to the reporting of applicability-related information regarding AI/ML model functionalities.

That said, in one option, when the UE transmits the RRC Resume Request message to the target network node 120b (e.g., a target gNodeB), the UE 110 is not configured with the AI/ML-model functionality. That is, the UE 110 does not have in its stored UE Context (e.g., UE Access Stratum Inactive context) the configuration of the AI/ML-model functionality. In other words, the AI/ML-model functionality configuration (e.g., reporting configuration for the UE to report one or more time-domain predictions of beam measurements such as predictions of SS-RSRP for a serving cell) is explicitly included in the RRC Resume message. In response to that configuration, the UE determines whether the AI/ML-model functionality is applicable or not.

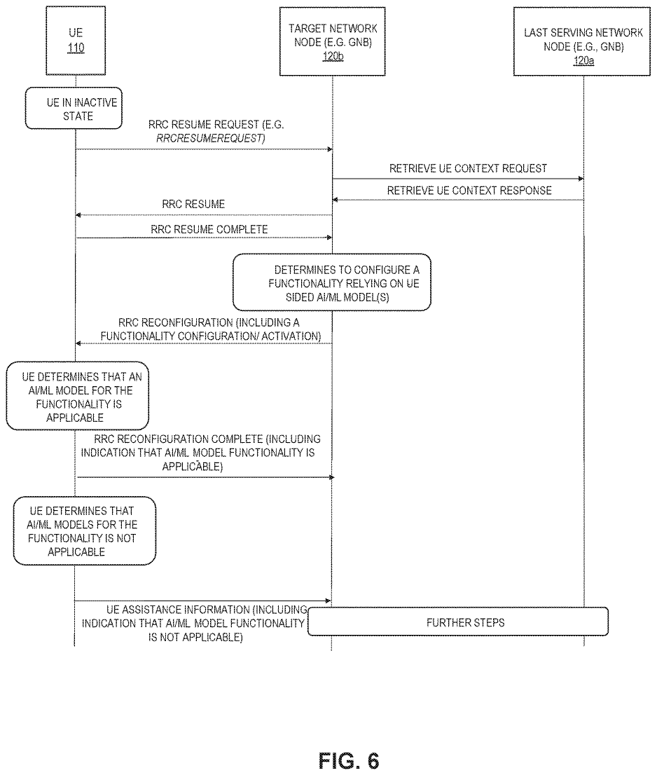

In some embodiments, the UE receives the AI-ML model functionality configuration (e.g. reporting configuration for the UE to report one or more time-domain predictions of beam measurements such as predictions of SS-RSRP for a serving cell) is configured in a subsequent RRC Reconfiguration message instead of RRC Resume message. An example of such a implementation is given below. In this example implementation, the UE receives the AI-ML model functionality configuration after transmitting the RRC Resume Complete message via an RRCReconfiguration message. At the time of receiving such a RRCReconfiguration message, the UE determines that the AI-ML model functionality configuration is applicable at that point in time and this includes an indication in the RRCReconfigurationComplete message to indicate that the AI-ML model functionality configuration is applicable. After transmitting the RRCReconfigurationComplete message, the UE continuous to monitor the applicability of AI/ML model(s) for the functionality for which the UE had acknowledged that the AI/ML-model is applicable in the complete message. If the UE determines that AI/ML model(s) for the functionality are not applicable, then the UE transmits an indication in a message (e.g., UEAssistanceInformation) to the network, the indication indicating that at least one of the configured AI/ML model functionality(ies) is not applicable. An example of an embodiment in which a UE sends an indication that AI/ML-model functionality is not applicable after transmitting an RRC Resume Complete message and also after subsequently sending a RRCReconfigurationComplete message is illustrated in the signaling diagram of FIG. 6.

In other embodiments, the AI/ML model functionality configuration is stored in the UE context but not the configuration related to the reporting of applicability-related information. In one option, when the UE 110 transmits the RRC Resume Request message to the target network node 120b (e.g., target gNodeB), the UE 110 is configured with the AI/ML-model functionality. That is, the UE has in its stored UE Context (UE Access Stratum Inactive context) the configuration of the AI/ML-model functionality. That AI/ML model functionality is restored when the UE receives the RRC Resume message (or when the UE transmits the RRC Resume Request message) and, the UE determines whether the restored AI/ML-model functionality, under the configuration resulting from the UE applying the RRC Resume message, is applicable or not.

When the UE determines that the AI/ML-model functionality is applicable the UE includes the indication (explicit or implicit) in the RRC Resume Complete message, and transmits the RRC Resume Complete message to the target network node, wherein the indication is indicating that the configured (or to be configured/to be activated) AI/ML-model functionality(ies), whose configuration is included in the RRC Resume, is applicable (e.g. under current scenario(s) and/or configuration).

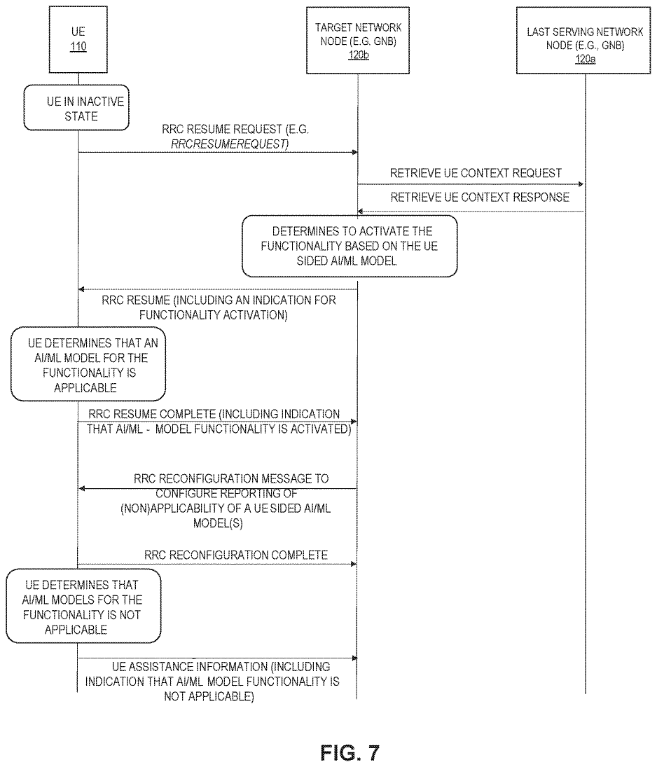

After transmitting the completion message, the UE receives a RRCReconfiguration message to configure the UE to report the (non)applicability of one or more AI/ML model functionalities. The UE thus monitors the applicability of AI/ML model(s) for the functionality (at least) for which the UE had acknowledged that the AI/ML-model is applicable in the complete message. If the UE determines that AI/ML model(s) for the functionality are not applicable anymore, then the UE transmits an indication in a message (e.g., UEAssistanceInformation) to the network, the indication indicating that at least one of the configured AI/ML model functionality(ies) is not applicable. An example is shown in the signaling diagram of FIG. 7.

In yet other embodiments, both the AI/ML model functionality configuration and the configuration related to the reporting of applicability-related information of AI/ML model functionalities is stored in the context. In one option, when the UE transmits the RRC Resume Request message to the target network node (e.g. target gNodeB), the UE is configured with the AI/ML-model functionality: i.e., the UE has in its stored UE Context (UE Access Stratum Inactive context) the configuration of the AI/ML-model functionality. That AI/ML model functionality is restored when the UE receives the RRC Resume message (or when the UE transmits the RRC Resume Request message) and, the UE determines whether the restored AI/ML-model functionality, under the configuration resulting from the UE applying the RRC Resume message, is applicable or not.

When the UE determines that the AI/ML-model functionality is applicable the UE includes the indication (explicit or implicit) in the RRC Resume Complete message, and transmits the RRC Resume Complete message to the target network node, wherein the indication is indicating that the configured (or to be configured/to be activated) AI/ML-model functionality(ies), whose configuration is included in the RRC Resume, is applicable (e.g. under current scenario(s) and/or configuration).

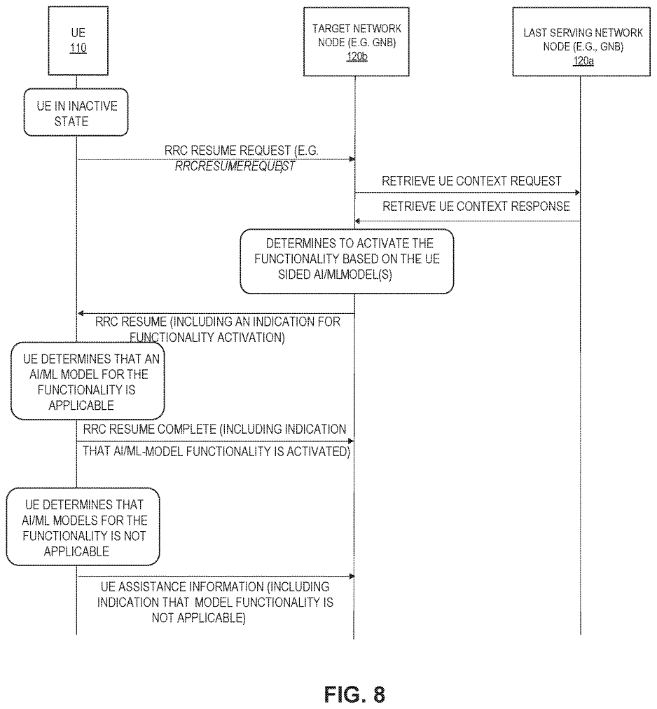

After transmitting the complete message, the UE continuous to monitor the applicability of AI/ML model(s) for the functionality (at least) for which the UE had acknowledged that the AI/ML-model is applicable in the complete message. If the UE determines that AI/ML model(s) for the functionality are not applicable anymore, then the UE transmits an indication in a message (e.g., UEAssistanceInformation) to the network, the indication indicating that at least one of the configured AI/ML model functionality(ies) is not applicable. An example flow chart that is generally consistent with such embodiments is illustrated in FIG. 8.

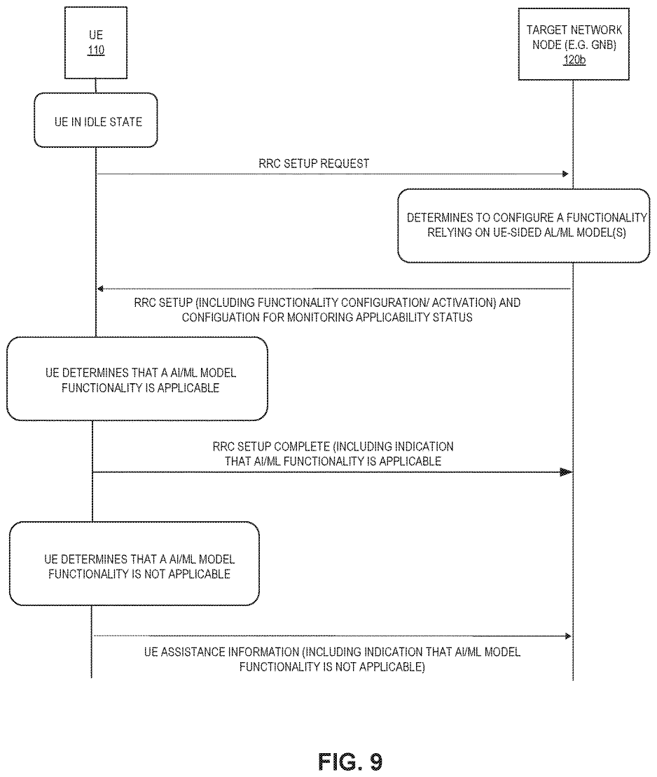

In contrast to some of the embodiments described above, other embodiments include a UE that transitions from idle mode (e.g., rather than from inactive mode) for configuration and reporting associated to applicability of a AI/ML model for a functionality. The signaling diagram of FIG. 9 illustrates one such example in which both an AI/ML model functionality Configuration and the configuration for reporting of applicability-related information is included in a setup message.

In some embodiments, a UE in an Idle state (e.g. RRC_IDLE) transmits to the network (e.g. a gNodeB) a request message (e.g. RRC Setup Request message, like RRCSetupRequest as defined in TS 38.331) and receives a response message (e.g. RRC Setup, like an RRCSetup message as defined in TS 38.331) based on which the UE enters a Connected state (RRC_CONNECTED), wherein the response message (e.g. RRCResume) configures (and/or activates) or tries to configure the UE with one or more AI/ML-model functionalites and also to monitor and report applicability-related information of the one or more AI/ML model functionalities.

In response of being configured with one or more AI/ML-model functionalities, in the RRC Setup message, the UE transmits a complete message to the network, such as an RRC Setup Complete message including at least one indication indicating that at least one of the configured AI/ML-model functionalities which are being configured (and/or activated) is (or is not) applicable (e.g., when the UE determines that the AI/ML-model is or is not applicable).

In response to receiving the configuration to monitor and report the applicability-related information of the one or more AI/ML model functionalities, the UE monitors the applicability criterion for the one or more AI/ML model functionalities (at least for those that the UE has positively acknowledged regarding the applicability of the AI/ML model functionalities). After transmitting the setup complete message, the UE continues to monitor the applicability of AI/ML models for the functionalities (at least) for which the UE had acknowledged that the AI/ML-model is applicable in the completion message. If the UE determines that AI/ML model(s) for the functionality are not applicable, then the UE transmits an indication in a message (e.g., UEAssistanceInformation) to the network, the indication indicating that at least one of the configured AI/ML model functionalities is not applicable.

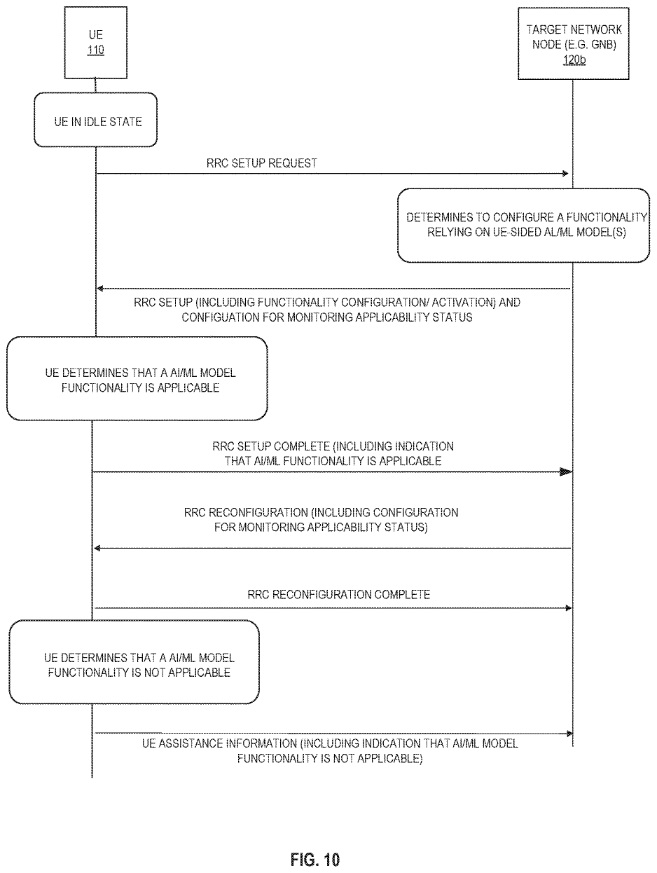

According to other embodiments, the AI/ML model functionality configuration is provided in a Setup message and the configuration for reporting of applicability-related information is provided in a first RRC Reconfiguration Complete. An example of such an embodiment is shown in FIG. 10.

In some such embodiments, a UE in an idle state (e.g. RRC_IDLE) transmits to the network (e.g. a gNodeB) a request message (e.g. RRC Setup Request message, like RRCSetupRequest as defined in TS 38.331) and receives a response message (e.g. RRC Setup, like an RRCSetup message as defined in TS 38.331) based on which the UE enters a Connected state (RRC_CONNECTED), wherein the response message (e.g. RRCResume) configures (and/or activates) or tries to configure the UE with one or more AI/ML-model functionalities.

In response of being configured with one or more AI/ML-model functionalities, in the RRC Setup message, the UE transmits a complete message to the network, such as an RRC Setup Complete message including at least one indication indicating that at least one of the configured AI/ML-model functionalities which is being configured (and/or activated) is (or is not) applicable (e.g., when the UE determines that the AI/ML-model is or is not applicable).

The UE receives a configuration message (e.g. RRC Reconfiguration, like an RRCReconfiguration message as defined in TS 38.331), wherein the message configures the UE with (non)applicability related reporting for one or more AI/ML-model functionalities (at least) those the UE has deemed applicable.

In response of being configured with (non)applicability related reporting for one or more AI/ML model functionalities, the UE transmits a complete message to the network (e.g. an RRC Reconfiguration Complete message) and monitors the applicability of the one or more AI/ML model functionalities.

After transmitting the reconfiguration complete message, the UE continues to monitor the applicability of AI/ML model(s) for the functionalities (at least) for which the UE had acknowledged that the AI/ML-model is applicable in the complete message. If the UE determines that AI/ML model(s) for the functionality are not applicable, then the UE transmits an indication in a message (e.g., UEAssistanceInformation) to the network, the indication indicating that at least one of the configured AI/ML model functionalities is not applicable.

Although some embodiments include neither the AI/ML model functionality configuration nor the configuration for reporting of applicability-related information in a setup message, such embodiments are similar to embodiments illustrated in FIG. 3.

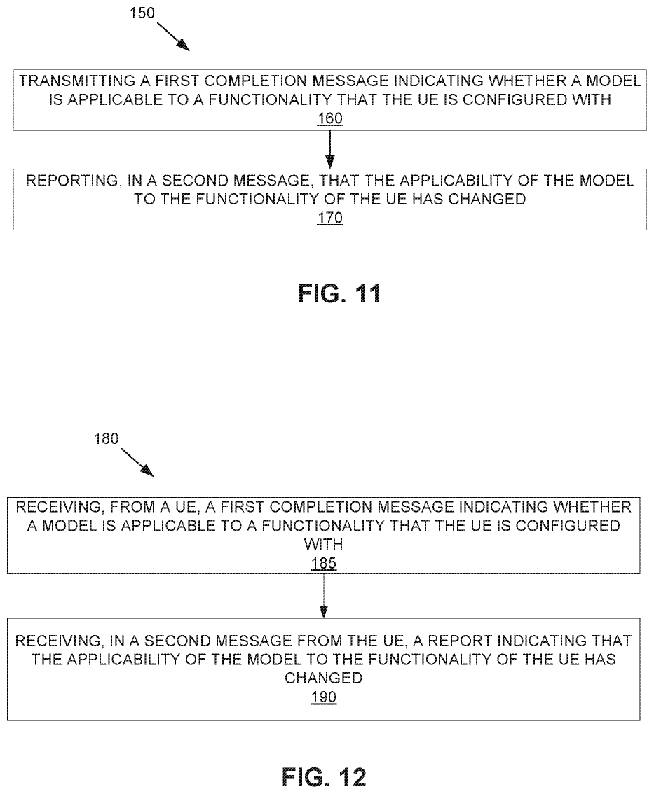

In view of the above, embodiments of the present disclosure include, for example, a method 150 implemented by a UE 110 as illustrated in FIG. 11. The method 150 comprises transmitting a first completion message indicating whether a model is applicable to a functionality that the UE 110 is configured with (block 160). The method 150 further comprises reporting, in a second message, that the applicability of the model to the functionality of the UE has changed (block 170).

Other embodiments include, for example, a method 180 implemented by a network node 120 as illustrated in FIG. 12. The method 180 comprises receiving, from a UE 110, a first completion message indicating whether a model is applicable to a functionality that the UE 110 is configured with (block 185). The method 180 further comprises receiving, in a second message from the UE 110, a report indicating that the applicability of the model to the functionality of the UE has changed (block 190).

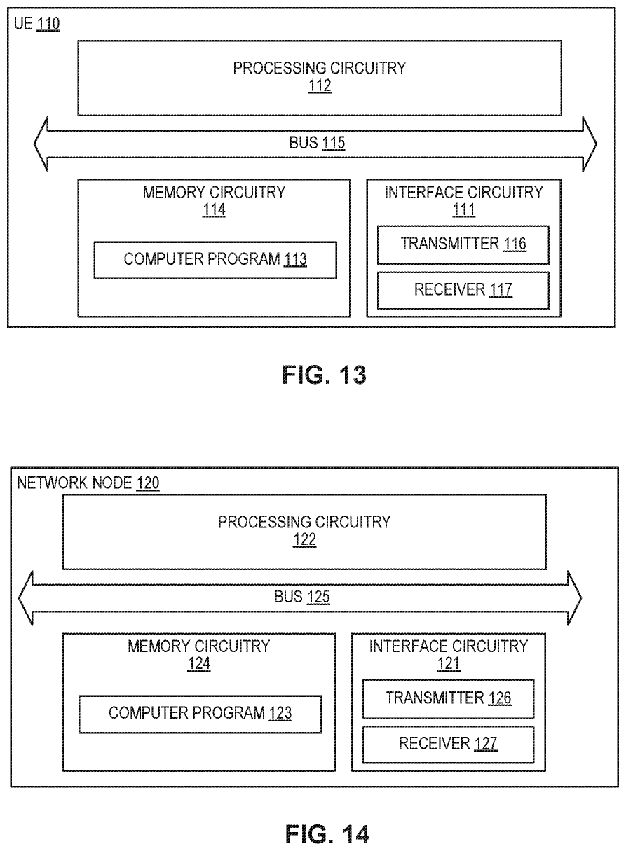

The UE 110 may, for example, be implemented as schematically illustrated in the example of FIG. 13. The UE 110 of FIG. 13 comprises processing circuitry 112, memory circuitry 114, and interface circuitry 111. The processing circuitry 112 is communicatively coupled to the memory circuitry 114 and the interface circuitry 111, e.g., via a bus 115. The processing circuitry 112 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 112 may be programmable hardware capable of executing software instructions stored, e.g., as a machine-readable computer program 113 in the memory circuitry 114. The memory circuitry 114 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 111 may be a controller hub configured to control the input and output (I/O) data paths of the UE 110. Such I/O data paths may include data paths for exchanging signals over a network. The interface circuitry 111 may be implemented as a unitary physical component, or as a plurality of physical components that are contiguously or separately arranged, any of which may be communicatively coupled to any other or may communicate with any other via the processing circuitry 112. For example, the interface circuitry 111 may comprise a transmitter 116 configured to send wireless communication signals and a receiver 117 configured to receive wireless communication signals.

The UE 110 may be configured to perform the method 150 described above. In one example, the processing circuitry 112 may be configured to transmit, via the interface circuitry 111, a first completion message indicating whether a model is applicable to a functionality the UE is configured with. The processing circuitry 112 may be further configured to report, in a second message via the interface circuitry 111, that the applicability of the model to the functionality of the UE has changed.

Still other embodiments include a computer program 113 comprising instructions that, when executed on processing circuitry 112 of a UE 110, cause the UE 110 to carry out the method 150 described above.

Yet other embodiments include a carrier containing the computer program 113. The carrier is one of an electronic signal, optical signal, radio signal, or computer readable storage medium.

Similarly, a network node 120 (e.g., gNodeB) may be implemented as schematically illustrated in the example of FIG. 14. The network node 120 of FIG. 14 comprises processing circuitry 122, memory circuitry 124, and interface circuitry 121. The processing circuitry 122 is communicatively coupled to the memory circuitry 124 and the interface circuitry 121, e.g., via a bus 125. The processing circuitry 122 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 122 may be programmable hardware capable of executing software instructions stored, e.g., as a machine-readable computer program 123 in the memory circuitry 124. The memory circuitry 124 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 121 may be a controller hub configured to control the input and output (I/O) data paths of the network node 120. Such I/O data paths may include data paths for exchanging signals over a network. The interface circuitry 121 may be implemented as a unitary physical component, or as a plurality of physical components that are contiguously or separately arranged, any of which may be communicatively coupled to any other or may communicate with any other via the processing circuitry 122. For example, the interface circuitry 121 may comprise a transmitter 126 configured to send wireless communication signals and a receiver 127 configured to receive wireless communication signals.

The network node 120 may be configured to perform the method 180 described above. In one example, the processing circuitry 122 may be configured to receive, from a UE 110 via the interface circuitry 121, a first completion message indicating whether a model is applicable to a functionality that the UE 110 is configured with. The processing circuitry 122 may be further configured to receive, in a second message from the UE 110 via the interface circuitry 121, a report indicating that the applicability of the model to the functionality of the UE 110 has changed.

Still other embodiments include a computer program 123 comprising instructions that, when executed on processing circuitry 122 of a network node 120, cause the network node 120 to carry out the method 180 described above.

Yet other embodiments include a carrier containing the computer program 123. The carrier is one of an electronic signal, optical signal, radio signal, or computer readable storage medium.

Although the computing devices described herein (e.g., UEs 110, network nodes 120) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry that processes information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, the devices described herein may comprise multiple different physical components that make up a single illustrated component, and functionality may be partitioned between separate components.

Additional embodiments will now be described. At least some of these embodiments may be described as applicable in certain contexts and/or wireless network types for illustrative purposes, but the embodiments are similarly applicable in other contexts and/or wireless network types not explicitly described.

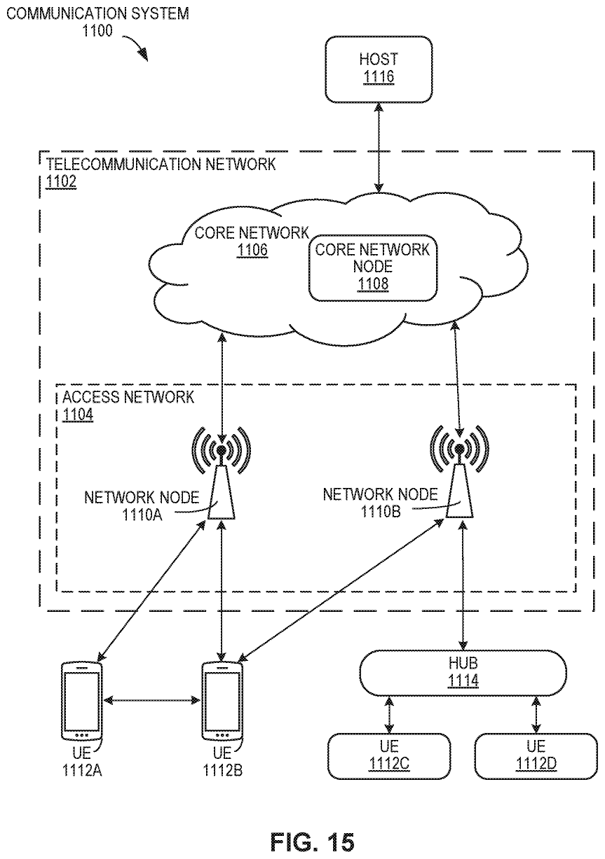

FIG. 15 shows an example of a communication system 11100 in accordance with some embodiments.

In the example, the communication system 11100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1102 includes one or more Open-RAN (ORAN) network nodes. An ORAN network node is a node in the telecommunication network 1102 that supports an ORAN specification (e.g., a specification published by the O-RAN Alliance, or any similar organization) and may operate alone or together with other nodes to implement one or more functionalities of any node in the telecommunication network 1102, including one or more network nodes 1110 and/or core network nodes 1108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

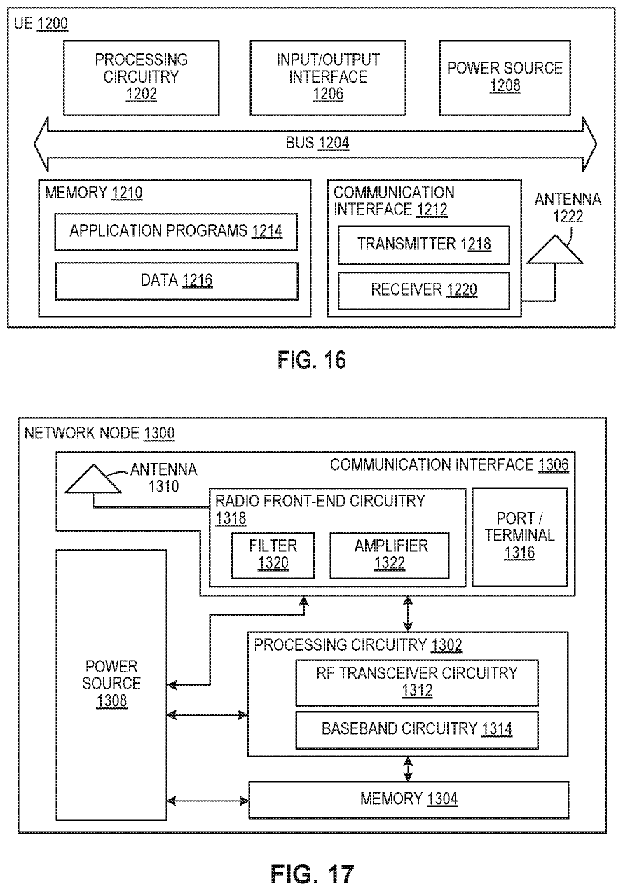

FIG. 16 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 17 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

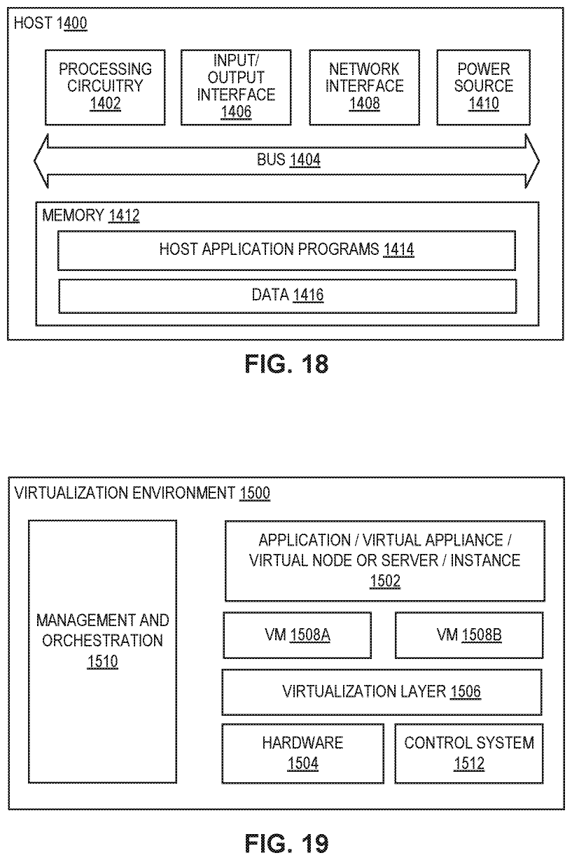

FIG. 18 is a block diagram of a host 1400, which may be an embodiment of the host 1116 of FIG. 15, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1500 includes components defined by the O-RAN Alliance, such as an O-Cloud environment orchestrated by a Service Management and Orchestration Framework via an O-2 interface.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

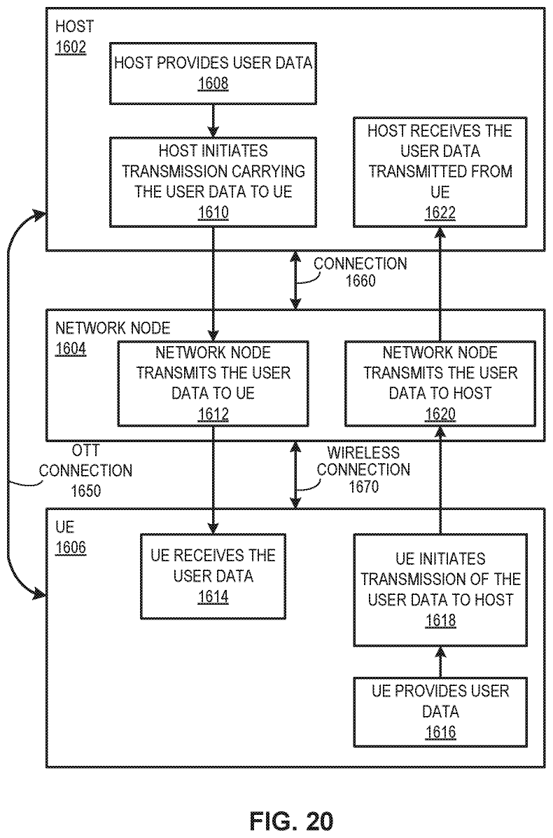

FIG. 20 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 15 and/or UE 1200 of FIG. 16), network node (such as network node 1110a of FIG. 15 and/or network node 1300 of FIG. 17), and host (such as host 1116 of FIG. 15 and/or host 1400 of FIG. 18) discussed in the preceding paragraphs will now be described with reference to FIG. 20.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 15) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve resource utilization, power consumption, and/or signal quality and thereby provide benefits such as improved quality of service, improved data rates, and/or improved battery life, among other things.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-32. (canceled)

33. A method, implemented by a User Equipment (UE), the method comprising:
transmitting a first completion message indicating whether a model is applicable to a functionality that the UE is configured with; and
reporting, in a second message, that the applicability of the model to the functionality of the UE has changed.

34. The method of claim 33, wherein the first completion message comprises a Radio Resource Control (RRC) Setup Complete message, an RRC Resume Complete message, or an RRC Reconfiguration Complete message.

35. The method of claim 33, wherein reporting that the applicability of the model has changed comprises indicating that the model is not applicable.

36. The method of claim 35, wherein reporting that the applicability of the model has changed comprises indicating an alternate model that is associated with the functionality and is applicable.

37. The method of claim 33, wherein reporting that the applicability of the model has changed comprises indicating that the model is applicable.

38. The method of claim 33, wherein reporting that the applicability of the model has changed comprises providing a cause value that indicates a reason why the model is or is not applicable.

39. The method of claim 33, wherein reporting that the applicability of the model has changed is responsive to receiving a third message configuring the reporting.

40. The method of claim 39, wherein the third message comprises an RRC Resume message, an RRC Setup message, or an RRC Reconfiguration message.

41. The method of claim 33, wherein the first completion message indicates a plurality of models, each of which is associated with a corresponding functionality that the UE is configured with.

42. The method of claim 33, wherein the second message reports applicability-related information about a plurality of models.

43. A User Equipment (UE), comprising:
interface circuitry and processing circuitry communicatively connected to the interface circuitry, wherein the processing circuitry is configured to:
transmit, via the interface circuitry, a first completion message indicating whether a model is applicable to a functionality that the UE is configured with; and
report, in a second message via the interface circuitry, that the applicability of the model to the functionality of the UE has changed.

44. A method, implemented by a network node, the method comprising:
receiving, from a UE, a first completion message indicating whether a model is applicable to a functionality that the UE is configured with; and
receiving, in a second message from the UE, a report indicating that the applicability of the model to the functionality of the UE has changed.

45. The method of claim 44, wherein the first completion message comprises a Radio Resource Control (RRC) Setup Complete message, an RRC Resume Complete message, or an RRC Reconfiguration Complete message.

46. The method of claim 44, wherein the report indicating that the applicability of the model to the functionality of the UE has changed comprises an indication that the model is not applicable.

47. The method of claim 46, wherein the report indicating that the applicability of the model to the functionality of the UE has changed comprises an indication of an alternate model associated to the functionality that is applicable.

48. The method of claim 44, wherein the report indicating that the applicability of the model to the functionality of the UE has changed comprises an indication that the model is applicable.

49. The method of claim 44, wherein the report indicating that the applicability of the model to the functionality of the UE has changed comprises a cause value that indicates a reason why the model is or is not applicable.

50. The method of claim 44, further comprising transmitting a third message that configures the UE to send the report, wherein receiving the second message is responsive to transmitting the third message.

51. The method of claim 50, wherein the third message comprises an RRC Resume message, an RRC Setup message, or an RRC Reconfiguration message.

52. The method of claim 44, wherein the first completion message indicates a plurality of models, each of which is associated with a corresponding functionality that the UE is configured with.

53. The method of claim 44, wherein the second message reports applicability-related information about a plurality of models.

54. A network node comprising:
interface circuitry and processing circuitry communicatively connected to the interface circuitry, wherein the processing circuitry is configured to:
receive, from a UE via the interface circuitry, a first completion message indicating whether a model is applicable to a functionality that the UE is configured with; and
receive, in a second message from the UE via the interface circuitry, a report indicating that the applicability of the model to the functionality of the UE has changed.
